(19) United States
(12) Patent Application Publication
(10) Pub. No.: US 2026/0177143 A1
(43) Pub. Date: Jun. 25, 2026

(54) SYSTEMS AND METHODS FOR IMPROVING EFFIENCY OF AUTOMATED MANUAL TRANMISSION (AMT) SHIFTING FOR A VEHICLE

(71) Applicant: Cummins Inc., Columbus, IN (US)

(72) Inventors: Oscar Li, Wuhan (CN); Bin Zhu, Wuhan (CN); Richard Zhou, Wuhan (CN)

(73) Assignee: Cummins Inc., Columbus, IN (US)

(21) Appl. No.: 19/424,834

(22) Filed: Dec. 18, 2025

(30) Foreign Application Priority Data
Dec. 20, 2024 (CN) 202411895705.4

(51) Int. Cl. F16H 61/02; F16H 59/14; F16H 59/18; F16H 59/36; F16H 59/44; F16H 59/66; F16H 59/78

(52) U.S. Cl. CPC F16H 61/0213; F16H 59/44; F16H 59/78; F16H 2059/147; F16H 2059/183; F16H 2059/366; F16H 2059/663; F16H 2061/022; F16H 2061/0232

(57) ABSTRACT

A computing system includes one or more processors and one or more memory devices storing instructions. The one or more processors perform operations according to the instructions. The operations include receiving an available gear value regarding a number of available gears of a transmission. The operations include responsive to the available gear value being above a predetermined gear value threshold, receiving a first efficiency value corresponding to a current gear and a second efficiency value corresponding to a first gear of the number of available gears of the transmission. The operations include implementing a gear shift that causes the transmission to operate at the first gear, responsive to the second efficiency value being below the first efficiency value.

### CROSS-REFERENCE TO RELATED APPLICATION

The present application claims the benefit of and priority to Chinese Non-Provisional Patent App. No. 202411895705.4 filed on Dec. 20, 2024, which is incorporated herein by reference in its entirety and for all purposes.

### TECHNICAL FIELD

The present disclosure relates to systems and methods for optimizing automated manual transmission (AMT) shifting for a vehicle.

### BACKGROUND

In vehicle systems, an automated manual transmission (AMT) shifting schedule is used to “shift” or change a gear level of a transmission. The shifting schedule can correlate a speed of the vehicle system to a predetermined gear level. For example, a lower vehicle speed may correspond to a lower gear level, while a higher vehicle speed may correspond to a higher gear level.

### SUMMARY

One embodiment relates to a computing system. The computing system includes one or more processors and one or more memory devices storing instructions that, when executed by the one or more processors, cause the one or more processors to perform operations. The operations include receiving an available gear value regarding a number of available gears of a transmission; responsive to the available gear value being above a predetermined gear value threshold, receiving a first efficiency value corresponding to a current gear and a second efficiency value corresponding to a first gear of the number of available gears of the transmission; and implementing a gear shift that causes the transmission to operate at the first gear, responsive to the second efficiency value being below the first efficiency value.

Another embodiment relates to a method. The method includes receiving an available gear value regarding a number of available gears of an transmission; responsive to the available gear value being above a predetermined gear value threshold, receiving a first efficiency value corresponding to a current gear and a second efficiency value corresponding to a first gear of the number of available gears of the transmission; and implementing a gear shift that causes the transmission to operate at the first gear, responsive to the second efficiency value being below the first efficiency value.

Still another embodiment relates to a non-transitory computer-readable medium having computer-executable instructions embodied therein that, when executed by at least one processor of a computing system, cause the computing system to perform operations. The operations include receiving an available gear value regarding a number of available gears of a transmission; responsive to the available gear value being above a predetermined gear value threshold, receiving a first exhaust gas temperature value operating at a current gear; responsive to the available gear value being above the predetermined gear value threshold and the first exhaust gas temperature value being at or below an exhaust gas temperature threshold, receiving a first efficiency value corresponding to the current gear, a second efficiency value corresponding to a first gear of the number of available gears of the transmission, a second exhaust gas temperature value of a vehicle operating at the first gear; and implementing a gear shift including at least one of: causing the transmission to operate at the first gear responsive to the second efficiency value being below the first efficiency value, or causing the transmission to operate at the first gear responsive to the second exhaust gas temperature value being above the first exhaust gas temperature value.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a system, according to an example embodiment.

FIG. 2 is a block diagram of the controller of the system of FIG. 1, according to an example embodiment.

FIG. 3 is a flow diagram of a method of implementing a gear shift for the system of FIG. 1, according to an example embodiment.

### DETAILED DESCRIPTION

Following below are more detailed descriptions of various concepts related to, and implementations of, methods, computer-readable media, and systems for optimizing speed and charging profiles for a vehicle. Before turning to the Figures, which illustrate certain exemplary embodiments in detail, it should be understood that the present disclosure is not limited to the details or methodology set forth in the description or illustrated in the Figures. It should also be understood that the terminology used herein is for the purpose of description only and should not be regarded as limiting.

As described herein, a vehicle may include a powertrain system, an exhaust aftertreatment system, and a thermal management system. The powertrain system may include a transmission, particularly an automated manual transmission (AMT) system, and an engine coupled to the transmission. The AMT system may include a plurality of gears or settings. In some embodiments, the AMT system shifts from a first gear or setting to a second gear or setting of the plurality of gears based on an operating characteristic of the engine, such as a brake specific fuel consumption of the engine. Advantageously, shifting gears or settings may improve the brake specific fuel consumption. During operation of the vehicle, a control system (e.g., controller) may control operation of the vehicle and/or one or more components or systems (e.g., the AMT system) thereof.

In an example embodiment, the control system may facilitate implementing a gear shift of the AMT system. In some embodiments, the control system facilitates implementing the gear shift responsive to a change in at least one of a road grade value, a vehicle speed value, or a throttle change rate value. The control system may determine at least one available gear or setting and compare one or more operating condition values of a current gear to one or more expected or predicted operating condition values of the at least one available gear. The “current gear” refers to a gear that is currently being used by the powertrain system. The “available gear” is a gear that is currently not in use by the powertrain system (e.g., the powertrain system is operating at a different gear than the available gears). The one or more operating condition values can include, for example, efficiency values, exhaust gas temperature values, and/or other values. The control system may compare efficiency values of the current gear and the at least one available gear to determine whether to implement a gear shift from the current gear to the available gear to improve the efficiency (e.g., of the engine). The “efficiency value” refers to at least one value indicating an efficiency of the vehicle (or a component and/or system thereof) as dictated by the gear position, such as a fuel economy value or an energy utilization value. For example, the control system may compare a brake specific fuel consumption value corresponding to the current gear with a brake specific fuel consumption value of each of the at least one available gear. As described herein, the “brake specific fuel consumption” (BSFC) refers to a ratio of a fuel consumption rate of an engine (e.g., measured in grams per second) to a power output by the engine (e.g., measured in watts). Thus, in some embodiments, the efficiency value is the brake specific fuel consumption value. The control system may implement a gear shift causing the AMT to operate at one of the at least one available gear, responsive to the brake specific fuel consumption value of the available bear being below the brake specific fuel consumption value of the current gear.

The “exhaust gas temperature value” refers to a temperature of the exhaust gas output by an engine. For example, in some embodiments, the exhaust gas temperature value is associated with a temperature of the exhaust gas at or proximate an aftertreatment system. In other embodiments, the exhaust gas temperature value is a temperature of the exhaust gas at or proximate an outlet of the engine. In still other embodiments, the exhaust gas temperature value is a temperature of the exhaust gas at an outlet of a turbocharger (e.g., a turbine outlet temperature (TOT)). The exhaust gas temperature value may fluctuate during operation of the vehicle, such as in response to gear shifts. For example, different gear positions may cause the engine to run or operate at different temperatures, which, in turn, impacts the exhaust gas temperature value. The control system may compare exhaust gas temperature value when operating at the current gear setting to each of the available at least one gears. In some embodiments, prior to comparing the exhaust gas temperature values, the control system may first determine whether the vehicle is running within certain predefined exhaust gas temperature thresholds. The exhaust gas temperature thresholds may include a minimum exhaust gas temperature threshold and a maximum exhaust gas temperature threshold. In some embodiments, the exhaust gas temperature thresholds may be based on, for example, a desired or target operating temperature value (or range of temperature values) for the aftertreatment system or a component thereof, such as a catalyst member. For example, the minimum exhaust gas temperature threshold may be based on a minimum desired temperature of exhaust gas flowing through the aftertreatment system (or components and/or systems thereof) and/or the minimum exhaust gas temperature to cause the aftertreatment system to operate as intended (e.g., at exhaust gas temperatures below the minimum temperature, the aftertreatment system may not convert NOx to other compounds, such as nitrogen gas or oxygen gas, at the rate or amount as desired). The maximum exhaust gas temperature threshold may be based on a maximum desired exhaust gas temperature of the aftertreatment system (or components and/or systems thereof), whereby exhaust gas temperatures above this value may cause damage to the aftertreatment system (or components and/or systems thereof). Responsive to determining that the exhaust gas temperature is between the temperature thresholds, the control system may compare the exhaust gas temperature values to determine a gear shift.

Advantageously, implementing the gear shift that results in a lower BSFC may result in improving powertrain efficiency and/or aftertreatment efficiency. In one embodiment, the “powertrain efficiency” refers to the BSFC of the engine of the powertrain. Accordingly, improving the powertrain efficiency includes decreasing the BSFC of the engine. In one embodiment, the “aftertreatment efficiency” refers to a ratio of the amount of harmful chemicals, such as NOx, that are removed (e.g., filtered out, converted into another chemical, etc.) by the aftertreatment system to the amount of harmful chemicals introduced to the aftertreatment system. For example, the aftertreatment efficiency may be a ratio of the amount of NOx converted into another chemical (e.g., water or diatomic nitrogen) relative to the amount of NOx received by the aftertreatment system. This ratio is referred to as a deNOx value. Accordingly, improving the aftertreatment system efficiency includes, for example, increasing the deNOx value. In another example, improving the aftertreatment system efficiency may include maintaining or approximately maintaining the same deNOx value while decreasing an amount of energy used to achieve the deNOx value. For example, improving the aftertreatment system efficiency may include reducing an amount of power used by a thermal management system to achieve or maintain a target aftertreatment system temperature, which, in turn, results in achieving or maintaining the deNOx value.

Conventional AMT systems may fail to account for both powertrain and aftertreatment system efficiency. For example, increasing a temperature of the engine may increase the aftertreatment efficiency by increasing the deNOx value with increasing the temperature of the aftertreatment system. Increasing the temperature of the aftertreatment system may promote catalytic activity and increase the deNOx value. Further, typical shifting schedules may account only for speed ratios, such as the engine speed to a current transmission speed. In these cases, gear shifts may be determined by predefined thresholds of the speed ratio, such as implementing a gear shift once the speed ratio meets an upshift (e.g., shifting gear from a lower to a higher gear) value. These AMT systems thus ignore factors such as road gradients and throttle positions, leading to inefficient vehicle operation. In contrast, the present disclosure accounts for the speed in addition to the efficiency of one or more, or both, of the powertrain and aftertreatment system to improve efficiency of the vehicle system overall. Combining both aftertreatment system and powertrain efficiency to develop a gear shift control process enables improved emissions and increases fuel economy.

Technically and beneficially, the systems, computer-readable media, and methods described herein address the technical problem of relying on speed ratios to determine gear shifts. That is, the systems, computer-readable media, and methods described herein automatically (e.g., without user input) implement a gear shift by dynamically calculating and implementing gear shifts based on the efficiency of at least one of the engine and the aftertreatment system. Advantageously, the systems and methods described herein may receive or determine, and implement gear shifts in real time or in near real time (e.g., less than one minute, less than one second, etc.), such that the gear shifts may be implemented more quickly to account for dynamic inputs that may change as a function of time, such as traffic conditions, weather conditions (e.g., snowy, rainy, cloudy, etc.). These and other features and benefits are described more fully herein below.

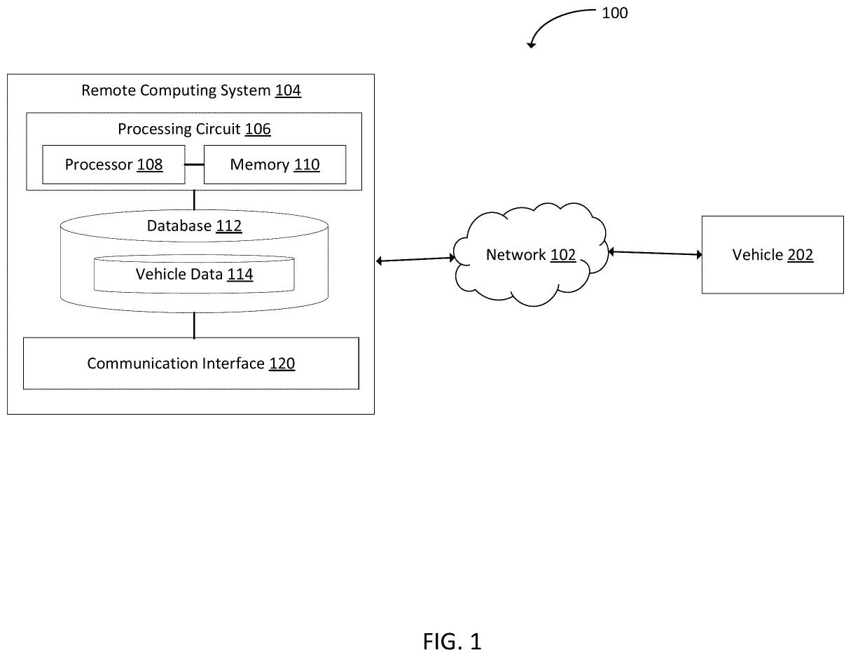

Now referring to FIG. 1, a schematic view of a block diagram of a system 100 is shown, according to an example embodiment. The system 100 includes a vehicle 202. In some embodiments, the vehicle 202 may be any type of on-road or off-road vehicle including, but not limited to, wheel-loaders, fork-lift trucks, line-haul trucks, mid-range trucks (e.g., pick-up truck, etc.), sedans, coupes, tanks, and any other type of vehicle.

As shown in FIG. 1, the system also includes at least one network 102 and a remote computing system 104. Each of the components of the system 100 are in communication with each other and are coupled by the network 102. Specifically, the remote computing system 104 and the controller 300 of the vehicle 202 are communicatively coupled to the network 102 such that the network 102 permits the direct or indirect exchange of data, values, instructions, messages, and the like (represented by the double-headed arrows in FIG. 1).

In some embodiments, the network 102 is configured to communicatively couple to additional computing system(s). In operation, the network 102 facilitates communication of data between the remote computing system 104 and other computing systems, such as the controller 140 of the vehicle 202. The network 102 may include one or more of a cellular network, the Internet, Wi-Fi, Wi-Max, a proprietary provider network, a proprietary service provider network, and/or any other kind of wireless or wired network.

The remote computing system 104 is a computing system such as a server, a cloud computing system, a backend server, and the like. Accordingly, as used herein, “remote computing system” can mean a computing or data processing system that has terminals distant from the central processing unit from which users and/or other computing systems communicate with the central processing unit. A “remote computing system” can also mean a computing or data processing system that is located remotely from a vehicle system, such as the vehicle 202. In some embodiments, the remote computing system 104 is part of a larger computing system such as a multi-purpose server, or other multi-purpose computing system. In other embodiments, the remote computing system 104 is implemented on a third-party computing device operated by a third-party service provider (e.g., AWS, Azure, GCP, and/or other third-party computing services).

In some embodiments, the remote computing system 104 is operated by a service provider (e.g., a business). Accordingly, in some embodiments, the remote computing system 104 is a service and/or system/component provider computing system and in turn controlled by, managed by, or otherwise associated with service and/or system/component provider (e.g., an engine manufacturer, a vehicle manufacturer, an exhaust aftertreatment system manufacturer, etc.). In the example shown, the remote computing system 104 is operated and managed by an engine manufacturer (which may also manufacture and commercialize other goods and services). Accordingly, an employee or other operator associated with the service and/or system/component provider may operate the remote computing system 104.

As shown in FIG. 1, the remote computing system 104 includes at least one processing circuit 106 having at least one processor 108 and at least one memory device 110. The remote computing system 104 further includes a database 112,, and a communications interface 120. The processing circuit 106 is coupled to, the database 112, and/or the communications interface 120.

The processing circuit 106 includes a processor 108 and a memory 110. The memory 110 is one or more devices (e.g., RAM, ROM, Flash memory, hard disk storage) for storing data and/or computer code for completing and/or facilitating the various processes described herein. The memory 110 is or includes non-transient volatile memory, non-volatile memory, and non-transitory computer storage media. The memory 110 includes database components, object code components, script components, or any other type of information structure for supporting the various activities and information structures described herein. The memory 110 is communicatively coupled to the processor 108 and includes computer code or instructions for executing one or more processes described herein. The processor 108 is implemented as one or more application specific integrated circuits (ASICs), field programmable gate arrays (FPGAs), a group of processing components, or other suitable electronic processing components. As such, the remote computing system 104 is configured to run a variety of application programs and store associated data in a database and/or the memory 110. The remote computing system 104 also includes a communications interface 120. The communications interface 120 may include any combination of wired and/or wireless interfaces (e.g., jacks, antennas, transmitters, receivers, transceivers, wire terminals) for conducting data communications with various systems, devices, or networks structured to enable and out-of-vehicle communications (e.g., with a remote server). For example, and regarding out-of-vehicle/system communications, the communications interface 120 may include an Ethernet card and port for sending and receiving data via an Ethernet-based communications network and/or a Wi-Fi transceiver for communicating via a wireless communications network. The communications interface 120 may be structured to communicate via local area networks or wide area networks (e.g., the Internet) and may use a variety of communications protocols (e.g., IP, LON, Bluetooth, ZigBee, radio, cellular, near field communication).

In an example embodiment, the communications interface 120 is structured to receive information from one or more vehicles 202 (e.g., via the network 102), and provide the information to the components of the remote computing system 104. The communications interface 120 is also structured to transmit data from the components of the remote computing system 104 to the one or more vehicles 202.

The memory 110 may store a database 112, according to some arrangements (alternatively, the database 112 may be separate from the memory 110). The database 112 retrievably stores data associated with the remote computing system 104 and/or any other component of the system 100. That is, the data includes information associated with each of the components of the system 100. For example, the data includes information about the one or more vehicles 202. The information about the one or more vehicles 202 includes vehicle data 114. The vehicle data 114 includes information received from the one or more vehicles 202 and/or metadata including information about the one or more vehicles 202. For example, the vehicle data 114 includes location information such as a vehicle location and/or a vehicle distance traveled. The vehicle data 114 also includes vehicle operational data, such as powertrain information (e.g., engine fuel consumption rate, a total fuel consumption over a predetermined time period or distance, etc.). The vehicle data 114 may include powertrain performance information such as powertrain work time, powertrain idle time, powertrain exhaust data (e.g., exhaust gas/particle concentration), and/or other powertrain operational parameters. The vehicle data 114 includes temperature information such as temperature of an aftertreatment system, and engine, and/or other temperature parameters of the vehicle (e.g., at various operating periods or representative metrics over various operating periods). The vehicle data 114 may include AMT performance information such as an amount of available gears, a fuel consumption value associated with each of the gears, and/or other AMT operational parameters described herein. The metadata may include a powertrain serial number, a vehicle identification number (VIN), a calibration identification and/or verification number, a make of the vehicle, a model of the vehicle, a unit number of a power unit of the vehicle, a unique identifier regarding a controller of the vehicle (e.g., a unique identification value (UID)), and/or a vehicle maintenance history (including a vehicle exhaust aftertreatment health history). Any of the data described above may include additional metadata such as a timestamp of when the data was gathered and/or when the data was transmitted or received by the remote computing system 104. The predetermined time periods described above may include a trip time, a work cycle (e.g., day, week, month, etc.), a time period between vehicle service, a predetermined vehicle lifespan, and the like.

In some embodiments, the memory 110 may be configured to store one or more applications and/or executables to facilitate tracking data (e.g., data regarding the operation of the vehicle 202, such as fuel economy), location information, and/or other information described herein), managing incoming emissions data requests or emissions tests, managing on-vehicle control systems, or any other operation described herein. In some arrangements, the applications and/or executables are incorporated with an existing application in use by the remote computing system 104. In some arrangements, the applications and/or executables are separate software applications implemented on the remote computing system 104. The applications and/or executables may be downloaded by the remote computing system 104 prior to its usage, hard coded into the memory 110 of the processing circuit 106, or be a network-based or web-based interface application such that the remote computing system 104 provides a web browser to access the application, which may be executed remotely from the remote computing system 104 (e.g., by a user device). Accordingly, the remote computing system 104 includes software and/or hardware capable of implementing a network-based or web-based application. For example, in some instances, the applications and/or executables include software such as HTML, XML, WML, SGML, PHP (Hypertext Preprocessor), CGI, and like languages.

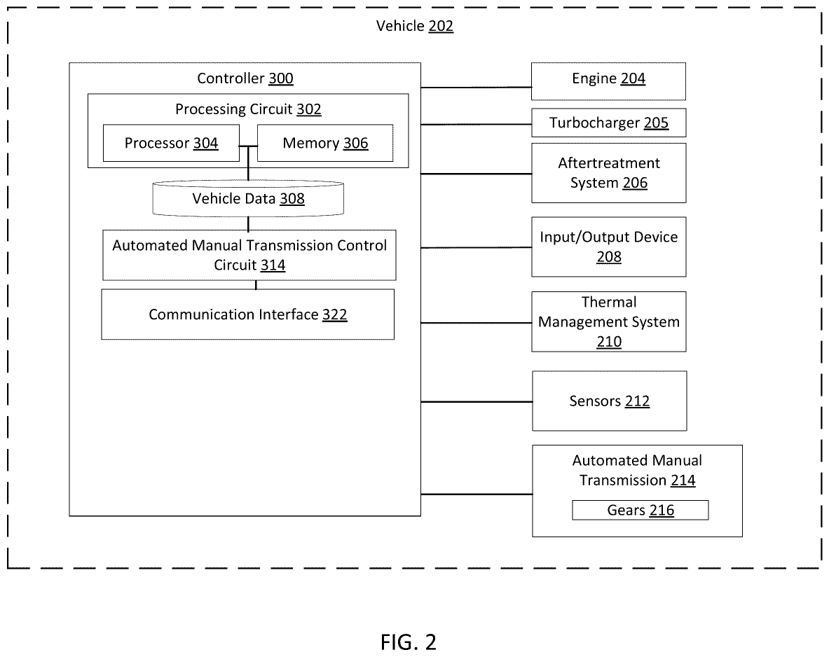

In one embodiment, the remote computing system 104 is structured to receive information regarding the vehicle 202 acquired from, for example, sensors 212 (shown in FIG. 2) of the vehicle 202. For example, the remote computing system 104 is structured to receive sensor data (e.g., vehicle operating data) from the vehicle 202 and/or sensor data from off-vehicle sensors via the communications interface 120. The received sensor data is stored in the database 112 (e.g., with the vehicle data 114).

In some embodiments, the remote computing system 104 is also structured to receive information regarding a road the vehicle 202 is on (e.g., road grade), a road condition (e.g., bumps, ice), and other environmental information (e.g., rain). The received information may be input into an AMT control circuit 314 (shown in FIG. 2) to determine the brake specific fuel consumption values. The remote computing system 104 may also further receive information regarding fuel tank levels, type of fuel, exhaust production, and any other measured vehicle parameters. As utilized herein, the term “measured” and like terms are used to refer to determining an approximate value based on detecting or receiving information regarding the measured value/parameter (e.g., using a sensor). The measured value may be close to the actual value (e.g., compared to estimating the value) but not necessarily exactly the actual value of the parameter value. As utilized herein, the term “estimating” and like terms are used to refer to determining an approximate value based on data (e.g., sensor data, historical sensor data, real-time sensor data, etc.), which may be close but not necessarily exactly the actual value. In some embodiments, estimating a value can be performed using one or more models (e.g., statistical models, artificial intelligence models, machine learning models, etc.). For example, estimating a temperature of exhaust gas can include using data, such as sensor data, with a model to determine the exhaust gas temperature value. In some embodiments, the term “predicting” is used to refer to estimating a potential future value.

As shown in FIG. 2, the vehicle 202 includes an engine 204, an aftertreatment system 206, an input/output device, 208, a thermal management system 210, one or more sensors 212, a transmission shown as an automated manual transmission (AMT) 214, and a controller 300, where the controller 300 is coupled to each of the aforementioned components. The AMT 214 has one or more gears 216. Each gear 216 corresponds to a predetermined gear ratio. The AMT 214 may have, for example, twelve gears 216. The vehicle 202 and the components thereof are described in greater detail herein below.

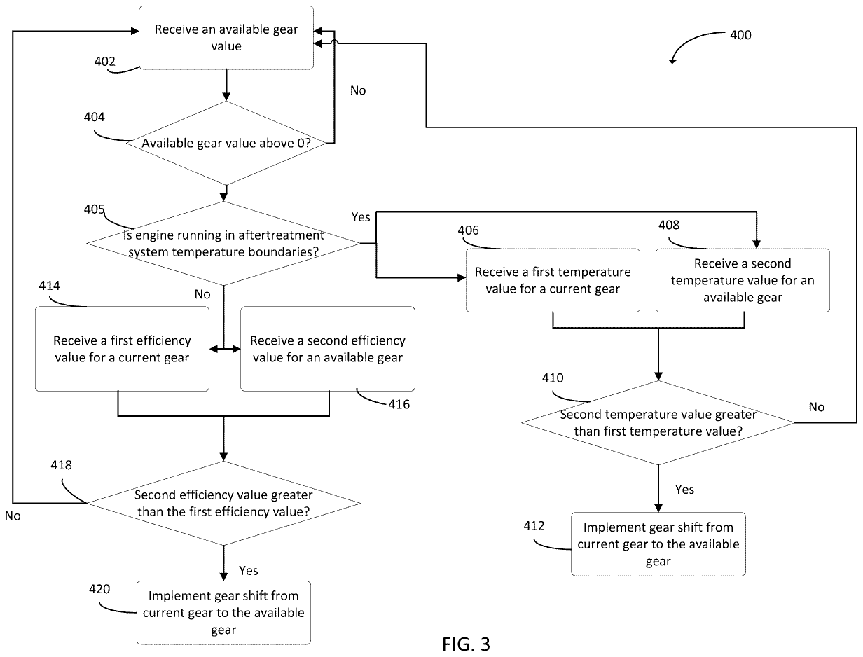

The remote computing system 104 can communicate with the controller 300. In various embodiments, remote computing system 104 is a cloud-based system and is not physically coupled to the vehicle 202 or any component thereof. In various embodiments, the remote computing system 104 is configured to generate a gear shift command for the vehicle 202. An example method of determining and implementing the gear shift command is shown and described herein with respect to FIG. 3.

In some embodiments, the remote computing system 104 may receive information from the controller 300. In some embodiments, remote computing system 104 may control operation of the vehicle 202 (e.g., by sending one or more commands, instructions, etc. to the control system of the vehicle). The remote computing system 104 may be configured to implement any of the methods described herein. For example, the remote computing system 104 may facilitate determining a gear shift.

FIG. 2 is a block diagram of a vehicle 202 of the system 100 of FIG. 1, according to an example embodiment. In some embodiments, the vehicle 202 may any type of passenger or commercial automobile, such as a commercial on-road vehicle including but not limited to, a line haul truck (e.g., a semi-truck, a school bus, a garbage truck, etc.); a non-commercial on-road vehicle, such as a car, truck, sport utility vehicle, cross-over vehicle, van, minivan, automobile; an off-road vehicle, such as tractor, airplane, boat, forklift, front end loader, etc.; and/or any other type of machine or vehicle that is suitable for the systems described herein.

The vehicle 202 is shown to include an engine 204. The engine 204 may be any type of internal combustion engine, such as a gasoline, natural gas, hydrogen fuel, and/or diesel engine, and/or any other suitable engine. In some embodiments, the engine 204 may be embodied in a hybrid engine system (e.g., a combination of the internal combustion engine and an electric motor). In other embodiments, the engine 204 is excluded and an only an electric engine is included with the vehicle (e.g., a full electric vehicle where power may come from a fuel cell, one or more batteries, etc.). For example, the vehicle 202 may include a fuel cell stack that includes individual membrane electrodes that use hydrogen and oxygen to produce electricity to power an electric engine, a fuel tank for storing hydrogen fuel, and one or more batteries for storing electrical power. The engine 204 may include one or more cylinders and associated pistons whereby the one or more cylinders may be arranged in a variety of ways (e.g., v-arrangement, inline, etc.). Air from the atmosphere is combined with fuel, and combusted, to produce power for the vehicle. Combustion of the fuel and air in the compression chambers of the engine 204 produces exhaust gas that is operatively vented to an exhaust pipe and to, in some embodiments, an exhaust aftertreatment system 206 (e.g., aftertreatment system 206). The engine 204 may also include an engine control module (ECM) to manage and control various aspects of the engine 204.

The engine 204 can also include or be coupled to a turbocharger 205. The turbocharger 205 can force more air, such as oxygen, into the engine 204 to increase the power output of the engine 204. While not shown, the vehicle 202 may also include additional systems, such as a lubrication system, a hydraulic system, and/or other systems.

The aftertreatment system 206 is coupled to the engine 204, and is structured to treat exhaust gases from the engine 204, which enter the aftertreatment system 206 via an exhaust pipe or conduit, in order to reduce the emissions of harmful or potentially harmful elements (e.g., NOx emissions, particulate matter, SOx, greenhouse gases, CO, etc.). The aftertreatment system 206 may include various components and systems, such as any combination of oxidation catalysts, particulate filters, and/or selective catalytic reduction (SCR) systems. The SCR system converts nitrogen oxides present in the exhaust gases produced by the engine 204 into diatomic nitrogen and water through oxidation within a catalyst. The oxidation catalyst is configured to oxidize hydrocarbons and carbon monoxide in the exhaust gases flowing in the exhaust gas conduit system. The particulate filter is configured to remove particulate matter, such as soot, from exhaust gas flowing in the exhaust gas conduit system. The aftertreatment system 206 may use an exhaust reductant (e.g., treatment fluid) to treat (e.g., decompose) the exhaust gases.

The vehicle 202 is also shown to include a controller 300. The controller 300 may be structured as one or more vehicle controllers/control systems, such as one or more electronic control units. The controller 300 may be separate from or included with at least one of a thermal management control unit, an exhaust aftertreatment control unit, a powertrain control module, an AMT control unit, an engine control module or unit, or other vehicle controllers. In one embodiment, the components of the controller 300 are combined into a single unit. In another embodiment, one or more of the components may be geographically dispersed throughout the system or vehicle. In this regard, various components of the controller 300 may be dispersed in separate physical locations of the vehicle 202. All such variations are intended to fall within the scope of the disclosure.

The vehicle 202 may include an operator input/output (I/O) device 208. The operator I/O 208 device may be coupled to the controller 300, such that information may be exchanged between the controller 300 and the I/O device 208, where the information may relate to one or more components of FIG. 1 or determinations (described below) of the controller 300. The operator I/O device 208 enables an operator of the system 100 to communicate with the controller 300 and one or more components of the system 100 of FIG. 1 and the vehicle 200. For example, the operator input/output device 208 may include, but is not limited to, an interactive display, a touchscreen device, one or more buttons and switches, voice command receivers, etc. In this way, the operator input/output device 208 may provide one or more indications or notifications to an operator, such as a malfunction indicator lamp (MIL), etc. Additionally, the vehicle 202 may include a port that enables the controller 300 to connect or couple to a scan tool so that fault codes and other information regarding the vehicle 202 may be obtained.

The vehicle 202 includes a thermal management system 210. The thermal management system 210 may include and be coupled to one or more components of the vehicle 202, such as the engine 204 and/or the aftertreatment system 206. The thermal management system 210 may include various components and sub-systems, such as any combination of a thermal management control unit (TMCU), various coolers (e.g., exhaust gas recirculation (EGR) cooler), heaters (e.g., electric heaters, ceramic heaters, etc.), heat exchangers, radiators, pumps, fans, and thermostats. The thermal management system 210 is structured to adjust a temperature of the one or more components of the vehicle 202. For example, the thermal management system 210 may monitor and adjust a temperature of the engine 204 and/or the aftertreatment system 206. For example, the thermal management system 210 may monitor, via the TMCU, a turbine outlet temperature (TOT) of the turbocharger 205 of the engine 204. The thermal management system 210 may also increase or decrease the TOT using, for example, a cooler or radiator, based on instructions from the controller 300. Adjusting the temperature of the TOT may include, for example, activating or increasing a power of a heater to change (e.g., increase) a temperature of exhaust gas flowing through the turbocharger 205.

The vehicle 202 includes an AMT 214. The AMT 214 may be coupled to one or more components of the vehicle 202, such as the engine 204. The AMT 214 is structured to automatically shift gears based on the received information (e.g., vehicle speed, engine speed, etc.). For example, based on a changing engine speed, the AMT 214 may adjust and implement a gear shift. Shifting gears may improve the brake specific fuel consumption of the vehicle 202 by, for example, increasing a speed or torque of the engine 204 and/or decreasing a fueling rate of the engine 204. The AMT 214 may include various components and systems, such as any combination of a gearbox, an automated clutch system, a transmissions control unit (TCU), and electronic controls systems. The TCU may manage operation of the AMT 214 and be communicatively coupled to the controller 300. The TCU may be communicatively coupled to the ECM to facilitate implementing gear shifts.

The AMT 214 may include a plurality of gears 216. Each of the plurality of gears 216 correspond to a different ratio, the ratio being a ratio between a rotational speed (RPM) of the engine 204 and rotational speed of wheels of the vehicle 202. The different ratios may be suited for different situations. For example, a lower ratio (e.g., lower gear) may provide higher torque and lower speed which could be suitable for roads with a higher road grade value. A higher ratio (e.g., higher gear) may provide lower torque and higher speed which could be suitable for lower, constant road grade values (e.g., cruising). The plurality of gears 216 are structured to transfer power between the engine 204 and the wheels and control an acceleration of the vehicle 202 as well as a speed of the vehicle 202 by shifting between gears of the plurality of gears 216. To optimize the brake specific fuel consumption of the engine 204, the AMT 214 may shift gears among the plurality of gears 216 while maintaining a speed of the vehicle 202 at or approximately at a desired speed.

A powertrain of the vehicle 202 may include the engine 204 and the AMT 214. The powertrain may further include various components and systems, such as a driveshaft, a differential, axles, a transfer case, a clutch, and a torque converter. For example, the engine 204 generates power which is then transferred by the plurality of gears 216 of the AMT 214. From there, a driveshaft translates rotational power of the plurality of gears 216 to the differential which distributes power to the wheels of the vehicle 202. The differential may allow the wheels to rotate at different speeds (e.g., distributes varying amounts of power to the wheels). The axles may connect the differential to the wheels while the transfer case allows for varying distribution of power between a front axle (e.g., front wheels) and a rear axle (e.g., rear wheels) of the vehicle 202. The clutch may connect and disconnect the engine 204 to the AMT 214 and may be operated by a user of the vehicle 202. The torque converter can connect the engine 204 to the AMT 214 to facilitate transitions between the plurality of gears 216.

The vehicle 202 includes a sensor array that includes a plurality of sensors, shown as sensors 212. The sensors 212 are coupled to the controller 300, such that the controller 300 can monitor, receive, and/or acquire data indicative of operation of the vehicle 202 (which may be referred to as operational data associated with the vehicle, operational parameters, and similar terms herein). Data indicative of operation of the vehicle 202 may be recorded and/or stored as the vehicle data 308 and/or the vehicle data 114. For example, the AMT control circuit 314 may utilize data provided by the sensors 212 to determine the gear shift. In this regard, the sensors 212 may include one or more physical (real) or virtual sensors (e.g., a non-physical sensor that is structured as program logic in the controller 300 that makes various estimations or determinations). When structured as a virtual sensor, at least one input may be used by the controller 300 in an algorithm, model, lookup table, etc. to determine or estimate a parameter of components of the vehicle 202 (e.g., power output, etc.). Any of the sensors 212 described herein may be real or virtual.

In some embodiments, the sensors 212 may include temperature sensors. The temperature sensors acquire data indicative of or, if virtual, determine or receive an approximate temperature of various components or systems at or approximately at the disposed location(s) of the sensors 212. The temperature sensors may be coupled to the thermal management system 210. For example, the TMCU may receive the temperature information from the temperature sensors and communicate the temperature information to the controller 300. For example, at least one of the sensors 212 may be located at or approximately at the aftertreatment system 206 to measure an exhaust gas temperature value of the exhaust gas at or proximate the aftertreatment system 206.

In some embodiments, the sensors 212 may include an emissions sensor that acquire data indicative of or, if virtual, determine or receive an approximate amount or concentration of emissions in the exhaust gas stream at or approximately at their disposed locations (e.g., immediately downstream of the engine 204, immediately downstream of the aftertreatment system, etc.). In some embodiments, the sensors 212 may include an exhaust aftertreatment sensor that acquires data indicative of or, if virtual, provides data to the controller 300 to determine a health of an exhaust aftertreatment system 206 of the vehicle 202. The health of the exhaust aftertreatment system may include a temperature of one or more components of the exhaust aftertreatment system (e.g., a catalyst), an indication of whether a diesel particulate filter (DPF) requires a regeneration, and/or other parameters associated with the health of the exhaust aftertreatment system. The sensors 212 may also include pressure sensors for sensing (or determining in the case of a virtual sensor) a pressure value at an upstream side and a downstream side of one or more of the components of the aftertreatment system. The upstream pressure value and the downstream pressure value may be used to determine a change of pressure across the aftertreatment system component. In some embodiments, the DPF may require a regeneration based on a predetermined schedule (e.g., a predetermined time period, a predetermined distance traveled, a predetermined duty cycle, etc.). The sensors 212 may also include a speed sensor that is configured to provide a speed signal to the controller 300 indicative of a vehicle speed. In some embodiments, there may be a sensor that provides a speed of the vehicle (e.g., miles-per-hour) while in other embodiments the speed of the vehicle may be determined by other sensed or determined operating parameters of the vehicle (e.g., engine speed in revolutions-per-minute (RPM) may be correlated to vehicle speed using one or more formulas, a look-up table(s), etc.).

The sensors 212 may include a fuel tank level sensor that determines, senses, or receives a level of fuel in the vehicle 202, such that a fuel economy may be determined based on the speed of the vehicle relative to the fuel consumed by the engine 204 (i.e., to determine a distance-per-unit of fuel consumed, such as miles-per-gallon or kilometers-per-liter, fuel consumption value of the engine 204, etc.). Additional examples of sensors 212 may be used alone or in combination to determine, sense, or receive a fuel economy for the vehicle 202 include, but are not limited to, an oxygen sensor, an engine speed sensor, a mass air flow (MAF) sensor, and a manifold absolute pressure sensor (MAP). Based on the foregoing, the controller 300 may determine a fuel economy for the vehicle 202 which may be provided to the operator via the I/O device 208. In electric and/or hybrid vehicles, the sensors 212 may include a battery sensor that determines, senses, or receives a state-of-charge of one or more batteries of the vehicle 202, such that the controller 300 may determine a distance-per-unit of battery charge consumed.

The sensors 212 may include a flow rate sensor that is structured to acquire data or information indicative of flow rate of a gas or liquid through the vehicle 202 (e.g., exhaust gas through an aftertreatment system or fuel flow rate through an engine, exhaust gas recirculation flow at a particular location, a charge flow rate at a particular location, an oil flow rate at various positions, a hydraulic flow rate at a particular location, etc.). The flow rate sensor(s) may be coupled to the engine 204, the aftertreatment system 206 of the vehicle 202, and/or elsewhere in the vehicle 202. The flow rate of the gas or liquid may be indicative of a brake specific fuel consumption of an operating state (e.g., speed, acceleration, etc.) of the vehicle 202.

In some embodiments, the sensors 212 are configured to acquire data regarding a vehicle speed, a vehicle position, a time value (e.g., amount of time elapsed since a predetermined instant in time), a transmission gear setting, an operating point of the engine 204 (e.g., a torque setting, a speed setting, etc.), a battery state of charge (SOC), and so on. For example, the sensors 212 may be coupled to and/or apart of the AMT 214 and provide speed and position information to the controller 300. It should be understood that other different/additional sensors may also be included with the vehicle 202, such as an accelerator pedal position (APP) sensor, a pressure sensor, an engine torque sensor, a battery sensor, etc. Those of ordinary skill in the art will appreciate and recognize the high configurability of the sensors and their associated positions in the vehicle 202. The controller 300 is structured to provide the operational data to a communicatively coupled device (e.g., the remote computing system 104) via a communications interface 322.

The controller 300 is coupled, and particularly communicably coupled, to the sensors 212. Accordingly, the controller 300 is structured to receive data from one or more of the sensors 212 and provide instructions/information to the one or more sensors 212. The controller 300 may use the received data to control one or more components in the vehicle 202 as described herein.

The controller 300 is structured to control, at least partly, the operation of the vehicle 202 and associated sub-systems, such as the AMT 214 and the thermal management system 210. Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (CAN) bus provides the exchange of signals, information, and/or data. The CAN bus includes any number of wired and wireless connections. The controller 300 may be communicably coupled to the systems and components of FIG. 2 and may be structured to receive data from one or more of the components shown in FIG. 2.

The communications interface 322 may include any type and number of wired and wireless protocols (e.g., any standard under IEEE 802, etc.). For example, a wired connection may include a serial cable, a fiber optic cable, an SAE J1939 bus, a CAT5 cable, or any other form of wired connection. In comparison, a wireless connection may include the Internet, Wi-Fi, Bluetooth, ZigBee, cellular, radio, etc. In one embodiment, a controller area network (CAN) bus including any number of wired and wireless connections provides the exchange of signals, information, and/or data between the controller 300 and the communications interface 322. In still another embodiment, the communication between the components of the vehicle 202 (e.g., the controller 300 and the communications interface 322) is via the unified diagnostic services (UDS) protocol.

As described above, the controller 300 may be structured to include the entirety of the communications interface 322 or include only a portion of the communications interface 322. In these latter embodiments, the communications interface 322 is communicatively coupled to a processing circuit 302. In other embodiments, the controller 300 is substantially separate from the communications interface 322. For example, the controller 300 and the communications interface 322 are separate control systems but may be communicatively and/or operatively coupled. The communications interface 322 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and, in some embodiments, out-of-vehicle communications (e.g., directly with the remote computing system 104). In this regard, in some embodiments, the communications interface 322 may include a network interface. The network interface is used to establish connections with other computing devices by way of the network 102. The network interface includes program logic that facilitates connection of the controller 300 to the network 102. The network interface includes any combination of a wireless network transceiver (e.g., a cellular modem, a Bluetooth transceiver, a Wi-Fi transceiver) and/or a wired network transceiver (e.g., an Ethernet transceiver). Thus, in some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. For example and regarding out-of-vehicle/system communications, the communications interface 322 may include an Ethernet card and port for sending and receiving data via an Ethernet-based communications network and/or a Wi-Fi transceiver for communicating via a wireless communications network. The communications interface 322 may be structured to communicate via local area networks and/or wide area networks (e.g., the Internet) and may use a variety of communications protocols (e.g., IP, LON, Bluetooth, ZigBee, radio, cellular, near field communication, etc.).

In the example shown, the controller 300 includes the processing circuit 302 having a processor 304 and a memory device 306. The processing circuit 302 may be configured to execute or implement the instructions, commands, and/or control processes described herein. The controller 300 may also include one or more specialized processing circuits shown as an AMT control circuit 314.

The processor 304 may be implemented as one or more single- or multi-chip processors, digital signal processors (DSPs), application specific integrated circuits (ASICs), field programmable gate arrays (FPGAs), and/or suitable processors (e.g., other programmable logic devices, discrete hardware components, etc. to perform the functions described herein). A processor may be a microprocessor, a group of processors, etc. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the AMT control circuit 314 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The at least one memory device 306 (e.g., memory, memory unit, storage device) may include one or more devices (e.g., RAM, ROM, Flash memory, hard disk storage) for storing data and/or computer code for completing or facilitating the various processes, layers and modules described in the present disclosure. For example, the memory device 306 may include dynamic random-access memory (DRAM). The memory device 306 may be communicably connected to the processor 304 to provide computer code or instructions to the processor 304 for executing at least some of the processes described herein. Moreover, the memory device 306 may be or include tangible, non-transient volatile memory or non-volatile memory. Accordingly, the memory device 306 may include database components, object code components, script components, or any other type of information structure for supporting the various activities and information structures described herein. The controller 300 may receive, acquire, determine, and/or capture data including vehicle operational parameters. “Vehicle operational parameters” refer to operational characteristics of the vehicle. The vehicle operational parameters may include, for example, a vehicle speed value, an engine speed value, an engine torque value, an engine temperature value, an aftertreatment system temperature value, an exhaust gas temperature value, and so on. The controller 300 may be configured to enable control the operation of the sensors 212. As one example, the controller 300 is communicatively coupled to the sensors 212 such that the controller 300 may cause the sensors 212 to detect certain vehicle operational parameters (e.g., the received information, the vehicle data 308) described herein. In another example, the controller 300 receives the vehicle operational parameters directly via one or more sensors onboard the vehicle. In yet another example, the controller 300 receives the vehicle operational parameters and determines the vehicle operational parameters from information from the sensors onboard the vehicle. The controller 300 may store the data (e.g., in the memory device 306). The controller 300 may provide the data to the remote computing system 104 via the communications interface 322.

In one embodiment, and as shown in FIG. 2, the controller 300 includes an AMT control circuit 314 that includes any combination of hardware and software for analyzing vehicle data such as the vehicle data 114 stored by the database 112. In one configuration, the AMT control circuit 314 is embodied as machine or computer-readable media storing instructions that are executable by a processor, such as processor 108. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media instructions may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the AMT control circuit 314 is embodied as a hardware unit, such as one or more electronic control units. As such, the AMT control circuit 314 may be embodied as one or more circuitry components including, but not limited to, processing circuitry, network interfaces, peripheral devices, input devices, output devices, sensors, etc. In some embodiments, the AMT control circuit 314 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the AMT control circuit 314 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on. The AMT control circuit 314 may also include or be programmable hardware devices such as field programmable gate arrays, programmable array logic, programmable logic devices or the like. The AMT control circuit 314 may include one or more memory devices for storing instructions that are executable by the processor(s) of the AMT control circuit 314. The one or more memory devices and processor(s) may have the same definition as provided below with respect to the memory 110 and processor 108. In some hardware unit configurations, the AMT control circuit 314 may be geographically dispersed throughout separate locations in the vehicle. Alternatively, and as shown, the AMT control circuit 314 may be embodied in or within a single unit/housing, which is shown as the remote computing system 104.

As an overview, the AMT control circuit 314 is structured to generate, based on analyzing the vehicle data 114 associated with the vehicle 202, a gear shift command for the vehicle 202. The gear shift command may be generated responsive to receiving information regarding the vehicle 202 or the operation thereof (e.g., the vehicle data 114). In one example, the received information includes a road grade value (e.g., incline of the road) of a road on which the vehicle 202 is traveling. The “road grade value” refers to a slope or incline of a surface of the road that the vehicle 202 is traveling on. In another example, the received information includes a vehicle speed value (e.g., speed of the vehicle 202). The “vehicle speed value” refers to a speed at which the vehicle 202 is traveling. In yet another example, the received information includes a throttle change rate value (e.g., a rate of change of a position of a throttle of the engine 204 of the vehicle 202). The “throttle change rate value” refers to a rate of change of the throttle position, which may be caused by a driver. In some embodiments, the remote computing system 104 is structured to receive data from the vehicle 202 via the communications interface 120. The received information is stored in the database 112 (e.g., with the vehicle data 114).

The AMT control circuit 314 may selectively implement or cause implementation of the gear shift command, thereby causing the AMT 214 of vehicle 202 to shift gears. Advantageously, when caused to shift gears in this way, at least one of the powertrain efficiency or the aftertreatment system efficiency of the vehicle 202 is improved. That is, the gear shift may result in decreasing the BSFC of the engine 204 and/or increasing the deNOx value of the aftertreatment system. In one example, responsive to receiving the received information, the AMT control circuit 314 may determine and/or receive that a different gear from a current gear may have a lower BSFC compared to the BSFC of the current gear. The AMT control circuit 314 may determine and/or receive the BSFC of the different gear by one or more look-up tables and/or one or more computer-executable models (e.g., machine learning models, etc.). The AMT control circuit 314 may take into account one or more parameters of the vehicle 202 to determine the brake specific fuel consumption, as described further herein.

In an example operating scenario, the AMT control circuit 314 is configured or structured to determine or receive an available gear value responsive to receiving the vehicle information (e.g., vehicle speed value, etc.). The available gear value is indicative of available gears for the vehicle 202, whereby the available gears refer to gears or settings that the transmission may implement. The AMT control circuit 314 is configured to determine that a gear 216 of the AMT 214 is an “available gear” based on, for example, a speed of the vehicle 202. For example, the AMT control circuit 314 may use one or more lookup tables or computer-implemented models (e.g., machine learning models) that correlate the speed of the vehicle 202 to the available gears.

Responsive to the available gear value being above a predetermined threshold, such as 0 gears, the AMT control circuit 314 may select a gear based on a brake specific fuel consumption value. As described above, the “brake specific fuel consumption” refers to a ratio of a fuel consumption rate (measured in grams per second) to a power output by the engine 204 (measured in watts). In some embodiments, the fuel consumption rate can be a measured value (e.g., where one or more sensors acquire data regarding the mass of a fuel that is provided to the combustion cylinders of an engine over a predefined period of time, such as a fuel mass flow rate value, a fuel rail pressure value, etc.) In other embodiments, the fuel consumption rate is based on a commanded fuel consumption rate, such as a commanded amount fuel mass flow rate, a command fuel rail pressure, a commanded air-to-fuel ratio, etc. The power output by the engine 204 is based on an engine speed (e.g., a rotational speed of the engine 204) and an engine torque. In some embodiments, one or both of the engine speed and the engine torque are measured values (e.g., one or more sensors 212 acquire data regarding the engine speed sensor, the engine torque, or both). In other embodiments, one or both of the engine speed and the engine torque are based on a commanded power value, such as a commanded torque value, a command speed value, etc. Accordingly, the “brake specific fuel consumption value” refers to the numerical value of the brake specific fuel consumption. The AMT control circuit 314 may receive a brake specific fuel consumption value for the current gear and/or for each available gear.

The AMT control circuit 314 may receive a first brake specific fuel consumption value for a current gear (e.g., the gear at which the vehicle 202 is operating) and a second brake specific fuel consumption value for a first available gear of the available gears. The first brake specific fuel consumption value may be calculated by the AMT control circuit 314 (e.g., based on one or more measured values and/or one or more commanded values). In some embodiments, the first brake specific fuel consumption value is received by the AMT control circuit 314. The second brake specific fuel consumption value may be a predicted brake specific fuel consumption value for operating the vehicle 202 at the first gear. Predicting the second brake specific fuel consumption value includes, for example, determining the fuel consumption rate, the engine speed value, and the engine torque value associated with operating the vehicle 202 at the first gear. In some embodiments, to determine or receive the second brake specific fuel consumption value, the AMT control circuit 314 uses one or more lookup tables or one or more computer-executable models that correlate inputs of the vehicle speed and the first gear with outputs of the fuel consumption rate, the engine speed value, and the engine torque value. Alternatively, the AMT control circuit 314 may use one or more lookup tables or one or more computer-executable models that correlate inputs of the vehicle speed and the first gear with the brake specific fuel consumption value, directly. The AMT control circuit 314 may compare the first brake specific fuel consumption value and the second brake specific fuel consumption value. Responsive to the second brake specific fuel consumption value being below the first brake specific fuel consumption value, the AMT control circuit 314 generates the gear shift command and implements the gear shift command, thereby causing the AMT to operate at the first gear.

In some embodiments, the AMT control circuit 314 compares a brake specific fuel consumption value for the current gear with a brake specific fuel consumption value for each available gear (e.g., a first gear, a second gear, a third gear, etc.). The AMT control circuit 314 can select a gear based on identifying the gear with a lowest brake specific fuel consumption value (e.g., among the current gear, the first gear, the second gear, and the third gear).

In some embodiments, the AMT control circuit 314 may generate the gear shift command based on temperature information of various components and/or systems of the vehicle 202. In one example, the temperature information may include an exhaust gas temperature value regarding the exhaust gas at the outlet of the engine 204, at or proximate the aftertreatment system 206. The AMT control circuit 314 is configured to receive a first exhaust gas temperature value based on a position of the current gear and compare the first exhaust gas temperature value to an exhaust gas temperature threshold. In one embodiment, the exhaust gas temperature threshold is a predetermined value that is set by a user or is based on a configuration or architecture of the engine and/or aftertreatment system 206. In another embodiment, the exhaust gas temperature threshold is a dynamic value that is determined or calculated based on the vehicle data 114. In other embodiments, the AMT control circuit 314 receives the exhaust gas temperature threshold from the memory 306. In still other embodiments, the temperature threshold may be determined based on a flow rate (e.g., a mass flow rate, a volumetric flow rate, etc.) of the exhaust gas. The temperature threshold can increase as the flow rate of exhaust gas increases and decrease as the flow rate of exhaust gas decreases. A higher flow rate of exhaust gas can transfer a greater amount of thermal energy to the aftertreatment system 206 compared to a lower flow rate of exhaust gas. Thus, the temperature threshold can increase with increased flow rates of exhaust gas as a temperature of the aftertreatment system 206 (e.g., a temperature of a component and/or system of the aftertreatment system) is increases along with the increased flow rate of exhaust gas. Advantageously, increasing the exhaust gas temperature threshold allows for the AMT control circuit 314 to select a gear based on the powertrain efficiency for a greater range of exhaust gas temperature values, which, in turn, may improve powertrain efficiency (e.g., by decreasing BSFC).

Responsive to the first exhaust gas temperature value being at or below the exhaust gas temperature threshold, the AMT control circuit 314 may receive a second exhaust gas temperature value corresponding to an available gear (e.g., a second available gear, etc.). The second exhaust gas temperature value may correspond to a predicted exhaust gas temperature value when the vehicle 202 is operating at the second gear. In some embodiments, to predict the exhaust gas temperature value, the AMT control circuit 314 uses one or more lookup tables or one or more computer-executable models that correlate inputs of the second gear with outputs of the exhaust gas temperature value. The look-up tables may be constructed from experimental data for vehicles having the same architecture (e.g., engine and aftertreatment system combinations) and operating at various operating conditions (e.g., speeds, environmental conditions, etc.).

The AMT control circuit 314 is configured to generate and implement the gear shift command, thereby causing the vehicle 202 to operate at the second gear responsive to the second exhaust gas temperature value being above the first exhaust gas temperature value. The second exhaust gas temperature value being above the first exhaust gas temperature value may be indicative of an improvement (e.g., increase) in the temperature of the aftertreatment system 206, a component thereof, or the exhaust gas flowing therethrough, while maintaining or decreasing the engine speed of the engine 204. The increased temperature may result in an improved deNOx value for the aftertreatment system 206. In some embodiments, operating at the second gear may increase the temperature of the aftertreatment system 206, a component thereof, or the exhaust gas flowing therethrough, while avoiding increasing the engine speed of the engine 204. In an example operating scenario, the second gear may be an upshift from the current gear which may cause the engine speed to decrease while causing the temperature of the exhaust gas to increase. Advantageously, the increase in exhaust gas temperature due to upshifting the gear may reduce a power needed by the thermal management system 210 to heat the exhaust gas to aid in reducing the emissions output by the engine 204 (e.g., via a catalytic reaction within the aftertreatment system 206).

In some embodiments, the AMT control circuit 314 compares an exhaust gas temperature value for the current gear with an exhaust gas temperature value for each available gear (e.g., a first gear, a second gear, a third gear, etc.). The AMT control circuit 314 can then select a gear based on the gear with a highest exhaust gas temperature value (e.g., among the current gear, the first gear, the second gear, and the third gear). In some embodiments, to compare the exhaust gas temperature value, the AMT control circuit 314 uses one or more lookup tables or one or more computer-executable models that correlate inputs of the current gear, the second gear, and the third gear with outputs of the exhaust gas temperature value.

In additional and/or alternative embodiments, the AMT control circuit 314 may receive the temperature information responsive to receiving the brake specific fuel consumption value(s). The AMT control circuit 314 may determine/generate/receive the gear shift command based on one or both of the temperature information and the brake specific fuel consumption values. For example, the AMT control circuit 314 compares the exhaust gas temperature value to the predetermined exhaust gas threshold. Responsive to the exhaust gas temperature value being below the exhaust gas threshold, the AMT control circuit 314 generates the shift command based on the exhaust gas temperature values, as described above. Responsive to the exhaust gas temperature value being above the exhaust gas threshold, the AMT control circuit 314 generates the shift command based on the BSFC value, as described above.

The AMT control circuit 314 is further configured to control and implement gear shifts of the plurality of gears 216 of the AMT 214, such that the AMT control circuit 314 allows for dynamic shifts of the gears. The AMT control circuit 314 may be communicatively coupled to the TCU to control and change the gears of the plurality of gears 216. In other embodiments, the AMT control circuit 314 may be a part of the TCU; or, the TCU may be included with the AMT control circuit 314 and a part of the controller 300 (an all-in-one unit). For example, responsive to the AMT control circuit 314 determining to shift gears from the first gears to the second gear, the AMT control circuit 314 implements the gear shift by controlling and operating the AMT 214. The controller 300 and/or one or more components thereof (e.g., the AMT control circuit 314) may generate and provide for implementation commands for controlling the gear shifts of the vehicle 202. More specifically, the controller 300 may generate and provide at least one command responsive to an increase in the road grade value that, causes the engine 204 to increase fueling in order to accelerate, and causes the AMT 214 to switch to a lower gear of the plurality of gears 216 to reduce a temperature value of the aftertreatment system 206 (e.g., by decreasing the exhaust gas temperature value). The commands generated by the controller 300 cause the vehicle 202 to implement gear shifts at a particular time and rate to improve the brake specific fuel consumption.

The AMT control circuit 314 is configured to control a temperature of various components and/or systems of the vehicle 202, such that the AMT control circuit 314 enables dynamic adjustment of the temperature of the engine 204, the aftertreatment system 206, and/or the AMT 214 by implementing a gear shift. As an example, responsive to the AMT control circuit 314 directing the controller 300 to implement a gear shift, the AMT control circuit 314 may also increase an exhaust gas temperature value to pursue a higher rate of conversion of one or more exhaust gas species (e.g., NOx) into less harmful compounds (e.g., O₂, N₂, etc.) within the aftertreatment system 206. In some embodiments, the controller 300, particularly the AMT control circuit 314, implements the gear shift, thereby changing (e.g., increases) an operating temperature of the engine 204, which, in turn, results in an increase in the exhaust gas temperature value. The controller 300 may use the vehicle data 308 to determine or receive the commands. The commands may be directed towards performing gear shifts and improving the brake specific fuel consumption of the vehicle 202. The controller 300, and particularly AMT control circuit 314, may be communicatively coupled to the TMCU to control and operate the thermal management system 210.

FIG. 3 is a flow diagram of a method 400 of determining and implementing a gear shift, according to an example embodiment. In particular, the controller 300 and/or the remote computing system 104 is configured to receive information to determine and/or receive and implement a gear shift. The controller 300 and/or the remote computing system 104 may use one or more models to determine the gear shift. The one or more models may be one or more of a combination of models, such as a regression model, a machine learning model such as artificial intelligence including neural networks, a dynamical model or dynamical equations obtained from data or derived from a foundational principle of physics, etc. It should be understood that the order of the method 400 is shown as an example only. That is, one or more processes may be performed concurrently, partially concurrently, sequentially, and/or in a different order than as shown in FIG. 3. Further, some processes of the method 400 may be omitted while other processes may be added to the method 400. The method 400 may be performed periodically and/or dynamically responsive to changes in, for example, information received from the sensors 212.

At process 402, the controller 300 and/or the remote computing system 104 receives or determines an available gear value regarding a number of available gears of the plurality of gears 216 of the AMT 214. The available gear value may be based on sensor data acquired by at least one of the sensors 212, such as a vehicle speed value, a road grade value, etc. The number of available gears may be received or determined responsive to receiving the vehicle operating data including, for example, at least one of the road grade value, the vehicle speed value, or the throttle change rate value. For example, based on the vehicle speed value, the number of available gears may be limited by vehicle speed value thresholds. The “vehicle speed value thresholds” refers to thresholds that limit the selection of available gears for the controller 300 and/or the remote computing system 104. For example, engine speeds (e.g., input speed) may govern which gears can be shifted to in order to match a speed of the engine 204 with a speed of the transmission (e.g., the AMT 214) to obtain a desired vehicle speed. Both the engine 204 and the AMT 214 include vehicle speed value thresholds. The vehicle speed value thresholds of the engine 204 and the AMT 214 are dynamic and align to obtain and maintain the desired vehicle speed. The lower vehicle speed value threshold and the upper vehicle speed value threshold may be different for the engine 204 and the AMT 214. The vehicle speed value thresholds may change as speeds of the engine 204 fluctuate. For example, lower speeds of the engine 204 may allow lower gears to be selected while higher speeds of the engine 204 allow higher gears to be selected.

In some embodiments, the controller 300 and/or the remote computing system 104 also receives information regarding the engine 204, the AMT 214, one or more vehicle 202 operating parameters, one or more environmental conditions (e.g., weather, road grade, etc.), and so on. In these embodiments, the controller 300 and/or the remote computing system 104 receives or determines the available gear value responsive to, for example, detecting a change in one or more operating parameters of the vehicle 202 and/or one or more environmental conditions, such as a change in the road grade value.

At process 404, the controller 300 and/or the remote computing system 104 compares the available gear value to a predetermined threshold (e.g., a gear value threshold). In some embodiments, the gear value threshold is zero. Thus, the controller 300 and/or the remote computing system 104 can determine or receive whether the available gear value is above zero. In some embodiments, responsive to the available gear value being above the gear value threshold, the method 400 may proceed to process 406 and process 408. In other embodiments, process 406 and/or process 408 are omitted from the method 400. In these embodiments, the responsive to the available gear value being above the gear value threshold, the method 400 may proceed to process 414 and process 416. Responsive to the available gear value being at or below the gear value threshold, the method 400 may return to process 402.

At process 405, the controller 300 and/or the remote computing system 104 determines whether the engine 204 is running in one or more aftertreatment system temperature boundaries. The term “aftertreatment system temperature boundaries” refers to a minimum temperature and a maximum temperature for which the aftertreatment system 206 operates at to convert the exhaust into less harmful compounds. The “minimum temperature” refers to a minimum temperature for the aftertreatment system 206 to operate at, below which may cause the aftertreatment system 206 to not perform as desired (e.g., convert NOx to less harmful compounds at the rate or amount as desired). The “maximum temperature” refers to a maximum temperature that the aftertreatment system 206 may operate at, above which may cause damage to the aftertreatment system 206. Responsive to determining that the engine 204 is running in the aftertreatment system boundaries, the method 400 proceeds to process 414 and process 316. Responsive to determining that the engine 204 is not running aftertreatment system boundaries, the method 400 proceeds to the process 406 and the process 408.

At process 406, responsive to the available gear value being above the gear value threshold, the controller 300 and/or the remote computing system 104 receives a first exhaust gas temperature value regarding the current gear. The controller 300 and/or the remote computing system 104 may receive the first exhaust gas temperature value from the sensors 212 located proximate at least one of the engine 204 or the thermal management system 210. The first exhaust gas temperature value regarding the current gear corresponds to a temperature of the engine 204 while the vehicle 202 is at a position of the current gear. Alternatively, the controller 300 and/or the remote computing system 104 may receive the first exhaust gas temperature value from the AMT control circuit 314. The first exhaust gas temperature value may be indicative of at least an engine temperature, an exhaust temperature, a TOT associated with the turbocharger 205, among others.

At process 408, responsive to the available gear value being above the gear value threshold, the controller 300 and/or the remote computing system 104 receives a second exhaust gas temperature value regarding a position of at least one gear (e.g., a first gear) of a plurality of gears 216 of the AMT 214. For example, the second exhaust gas temperature value indicates a temperature of the engine 204 based on the AMT 214 being in a first gear setting. The second exhaust gas temperature value is a predicted exhaust gas temperature value of the aftertreatment system 206 and/or the engine 204 of the vehicle 202, if the vehicle 202 were to operate at the first gear. For example, the first gear may be an upshift (e.g., higher gear) from the current gear, and cause a temperature increase of the aftertreatment system 206 due to the hotter exhaust gases. To determine the exhaust gas temperature value for each gear setting, the controller 300 and/or the remote computing system 104 may include at least one model, function, simulation, or look-up table. For example, the controller 300 and/or the remote computing system 104 computes the exhaust gas temperature value for each gear setting based on a position of the gear and the vehicle operating conditions. The controller 300 and/or the remote computing system 104 can compute changes to the temperature of various components of the vehicle 202, such as the engine 204 or the aftertreatment system 206, based on changes to torque or speed of the engine 204 in response to the position of the gear (e.g., different gear settings). The controller 300 and/or the remote computing system 104 may include a model including a plurality of weights which the model updates as the vehicle 202 performs gear shifts and vehicle operating conditions change. The model may receive gear settings and vehicle operating conditions as an input, and output exhaust gas temperature values for each gear setting.

In some embodiments, the controller 300 and/or the remote computing system 104 may receive the second exhaust gas temperature value responsive to the first exhaust gas temperature value being at or below a temperature threshold as well. In some embodiments, the temperature threshold is a predetermined value. In other embodiments, the temperature threshold is a dynamic value that is determined and/or set by the controller 300 and/or the remote computing system 104 based on the current gear. For example, the temperature threshold may be a target temperature of the aftertreatment system 206, or a component thereof, such as a catalyst member, where achieving the target temperature would improve the aftertreatment efficiency. The temperature threshold may be adjusted (e.g., increased or decreased) based on the current gear as a higher gear may improve the load of the engine which may increase the temperature and subsequently decrease energy usage of the thermal management system 210 for the aftertreatment system 206. For example, operating at the higher gear indicates lower engine speed (e.g., RPM) and higher engine torque. This may result in hotter exhaust gases (e.g., compared to lower gears) due to the engine 204 burning more fuel per combustion cycle.

In some embodiments, the controller 300 and/or the remote computing system 104 also receives additional exhaust gas temperature values (e.g., a third exhaust gas temperature value, a fourth exhaust gas temperature value, etc.) corresponding to additional gears of the available gears (e.g., a second gear, a third gear, etc.). The additional exhaust gas temperature values are predicted exhaust gas temperature values of the aftertreatment system 206 and/or the engine 204 of the vehicle 202 operating at the corresponding gears. For example, the second gear may be an upshift (e.g., higher gear) from the current gear, and cause a temperature increase of the aftertreatment system 206 due to the hotter exhaust gases. The second gear being an upshift may also decrease a speed of both the vehicle 202 and the engine 204 while also decreasing a load of the engine 204. The controller 300 and/or the remote computing system 104 may determine the exhaust gas temperature values as a function of at least one of the road grade value, the vehicle speed value, or the throttle change rate value (among others). For example, a higher gear setting may cause the engine 204 to run at lower temperatures while higher road grade values may cause load and temperature of the engine 204 to increase. The controller 300 and/or the remote computing system 104 can thus calculate and/or receive the exhaust gas temperature values based on the road grade value and the setting of the at least one available gears of the transmission (e.g., the AMT 214). As another example, the controller 300 and/or the remote computing system 104 may access one or more lookup tables corresponding each position of the available gears to the temperature of the engine 204 based on the vehicle operating data.

At process 410, the controller 300 and/or the remote computing system 104 compares the first exhaust gas temperature value to the second exhaust gas temperature value. In some embodiments, responsive to the first exhaust gas temperature value being at or above the second exhaust gas temperature value (e.g., when implementing a gear shift to the first gear would not result in an increase in the exhaust gas temperature and, therefore, an increase in temperature of the engine 204 and/or the aftertreatment system 206), the method proceeds to process 414 and/or process 416. In other embodiments, process 414 and/or process 416 are omitted from the method 400. In these embodiments, responsive to the first exhaust gas temperature value being at or above the second exhaust gas temperature value, the method 400 returns to process 402. Responsive to the first exhaust gas temperature value being below the second exhaust gas temperature value, the method 400 proceeds to process 412.

At process 412, responsive to the second exhaust gas temperature value being above the first exhaust gas temperature value, the controller 300 and/or the remote computing system 104 implements the gear shift. For example, the controller 300 and/or the remote computing system 104 may cause the AMT 214 to implement a gear shift (e.g., via the AMT control circuit 314). Implementing the gear shift includes causing the AMT 214 to operate at the first gear. For example, the AMT 214 may change from the current gear to the first gear. Advantageously, implementing the gear shift at process 412 may improve the aftertreatment system efficiency (e.g., due to increasing the aftertreatment system temperature, thereby increasing the deNOX value and/or due to less power and/or energy needed from the thermal management system 210 to maintain the same aftertreatment system temperature).

At process 414, responsive to the second exhaust gas temperature value being below the first exhaust gas temperature value, the controller 300 and/or the remote computing system 104 receives a first efficiency value. The first efficiency value corresponds to the vehicle 202 operating at a current gear.

At process 416, responsive to the second exhaust gas temperature value being below the first exhaust gas temperature value, the controller 300 and/or the remote computing system 104 receives an efficiency value at process 416. The second efficiency value corresponds to the vehicle 202 operating at a first gear of the available gears of the plurality of gears 216. The first gear is one gear of the available gears of the plurality of gears 216. The available gear is different than the current gear.

The first efficiency value and the second efficiency value may be calculated and/or received by the controller 300 and/or the remote computing system 104. The first efficiency value and the second efficiency value may be calculated and/or received by mathematical equations, models, physics models, and/or simulation models.

In some embodiments, the first efficiency value is based on at least one of the engine speed value (e.g., engine RPM value), the engine torque value, or a vehicle speed value. The engine speed value, the engine torque value, and/or the vehicle speed value may be indicative of the efficiency of the vehicle 202. For example, a higher engine speed value may indicate a lower efficiency of the vehicle 202. The controller 300 and/or the remote computing system 104 may receive or determine and/or calculate the efficiency values based on a fuel mass flow rate over a brake power output of the engine 204. The fuel mass flow rate may be determined based on the sensor 212 configured to determine, sense, or receive fuel flow. The brake power output may be converted from torque and engine speed of the engine 204, as provided by the sensors 212.

As described above, the second efficiency value may be a predicted (e.g., simulated) value of the efficiency. Predicting the second efficiency value includes, for example, determining the fuel consumption rate, the engine speed value, and the engine torque value associated with operating the vehicle 202 at the first gear. In some embodiments, to determine or receive the second efficiency value, the AMT control circuit 314 uses one or more lookup tables or one or more computer-executable models that correlate inputs of the vehicle speed and the first gear with outputs of the fuel consumption rate, the engine speed value, and the engine torque value. The second efficiency value may be calculated and/or received based on the received information, the vehicle data 308, and a ratio of the first gear.

At process 418, the controller 300 and/or the remote computing system 104 compares the first efficiency value and the second efficiency value. Responsive to the first efficiency value being at or above the second efficiency value (e.g., shifting to the first gear would not result in a decrease in the efficiency value) the method 400 returns to process 402. Responsive to the first efficiency value being below the second efficiency value, the method 400 proceeds to process 420.

In some embodiments of the method 400, the controller 300 and/or the remote computing system 104 receive additional efficiency values at process 414 and/or 416, where each additional efficiency value corresponds to one gear of the available gears. For example, a third efficiency value may correspond to a second gear of the plurality of gears 216. The controller 300 and/or the remote computing system 104 compares the first efficiency value, the second b efficiency value, and the additional efficiency values. Responsive to the third efficiency value being lower than the first and the second efficiency values, the AMT control circuit 314 may cause the plurality of gears 216 to shift from the current gear to the second gear. The controller 300 may receive any number of efficiency values corresponding to the number of available gears. For example, responsive to the number of available gears being five, the controller 300 receives six efficiency values (one for the current gear and one for each of the available gears). The controller 300 may then determine or receive a gear shift based on a lowest efficiency value. The six efficiency values may be calculated and/or received based on the received information, the vehicle data 308, and a ratio of a respective gear.

In some embodiments, following comparison of the second efficiency value to the first efficiency value, the method 400 proceeds to process 406 and process 408. In other embodiments, the method 400 proceeds to process 406 and process 408 following implementation of the gear shift. For example, after selecting a gear shift based on the comparison of process 418, the method 400 may then compare exhaust gas temperature values of the selected gear to other available gears and decide the gear shift based on the exhaust gas temperature values following comparison of the efficiency values.

At process 420, responsive to the second efficiency value being below the first efficiency value, the controller 300 and/or the remote computing system 104 implements the gear shift. Implementing the gear shift includes causing the AMT 214 to operate at the first gear. For example, the controller 300 and/or the remote computing system 104 may cause the AMT 214 to shift from the current gear to the first gear. Advantageously, the lower efficiency associated with operating at the first gear may result in decreasing the fuel consumption of the vehicle 202, which may be indicative of an improved powertrain efficiency of the vehicle 202.

In some embodiments, to implement the gear shift, the controller 300 and/or the remote computing system 104 may implement the gear shift based on the second efficiency value being below the first efficiency value and/or the second exhaust gas temperature value being above the first exhaust gas temperature value. In some embodiments, the controller 300 and/or the remote computing system 104 considers both the efficiency values and the exhaust gas temperature values. In this case, the controller 300 and/or the AMT control circuit 314 may determine or receive the efficiency values and the exhaust gas temperature values and implement the gear shift based on the lowest overall fuel consumption.

While many of the references to certain steps of various processes herein are in reference to an exhaust gas temperature value, it should be understood that other temperature values may be used in other embodiments without departing from the spirit and scope of the present disclosure. For example, an aftertreatment system or component temperature may be used in other embodiments. In another example, an engine temperature itself may be used. In yet other embodiments, different temperature values may be used (e.g., an average of an engine out exhaust gas temperature and an aftertreatment system temperature inlet value). Further, the values may be instantaneous values, moving averages, maximum or minimum values over a predefined operating period, and/or some other desired representative value without departing from the scope of the instant disclosure.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 300 may include any number of circuits for completing the functions described herein. For example, the activities and functionalities of the processing circuit 302 may be combined in multiple circuits or as a single circuit. Additional circuits with additional functionality may also be included. Further, the controller 300 may further control other activity beyond the scope of the present disclosure.

As mentioned above and in one configuration, the “circuits” may be implemented in machine-readable medium for execution by various types of processors, such as the AMT control circuit 314 of FIG. 2. Executable code may, for instance, comprise one or more physical or logical blocks of computer instructions, which may, for instance, be organized as an object, procedure, or function. Nevertheless, the executables need not be physically located together but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object-oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A computing system comprising:
one or more processors; and
one or more memory devices storing instructions that, when executed by the one or more processors, cause the one or more processors to perform operations comprising:
receiving an available gear value regarding a number of available gears of a transmission;
responsive to the available gear value being above a predetermined gear value threshold, receiving a first efficiency value corresponding to a current gear and a second efficiency value corresponding to a first gear of the number of available gears of the transmission; and
implementing a gear shift that causes the transmission to operate at the first gear responsive to the second efficiency value being below the first efficiency value.

2. The computing system of claim 1, wherein the predetermined gear value threshold is zero.

3. The computing system of claim 1, wherein the available gear value is received responsive to receiving information comprising at least one of a road grade value, a vehicle speed value, or throttle change rate value, and wherein the available gear value is based on the received information.

4. The computing system of claim 1, wherein the instructions, when executed by the one or more processors, cause the one or more processors to perform further operations comprising:
comparing the first efficiency value and the second efficiency value to a third efficiency value corresponding to a second gear of the number of available gears of the transmission; and
wherein implementing the gear shift comprises causing the transmission to operate at the second gear responsive to the third efficiency value being below both the first efficiency value and below the second efficiency value.

5. The computing system of claim 1, wherein the instructions, when executed by the one or more processors, cause the one or more processors to perform further operations comprising:
responsive to the available gear value being above the predetermined gear value threshold, receiving a first exhaust gas temperature value while operating in the current gear; and
responsive to the first exhaust gas temperature value being at or below an exhaust gas temperature threshold, comparing the first exhaust gas temperature value to a second exhaust gas temperature value corresponding to a second gear of the number of available gears of the transmission;
wherein implementing the gear shift comprises causing the transmission to operate at the second gear responsive to the second exhaust gas temperature value being above the first exhaust gas temperature value.

6. The computing system of claim 5, wherein the first gear and the second gear are the same gear.

7. The computing system of claim 5, wherein the first efficiency value and the second efficiency value are received responsive to the first exhaust gas temperature value being below the exhaust gas temperature threshold.

8. The computing system of claim 1, wherein the first efficiency value corresponding to the current gear is based on at least one of an engine speed value, an engine torque value, or a vehicle speed value.

9. A method, comprising:
receiving an available gear value regarding a number of available gears of a transmission;
responsive to the available gear value being above a predetermined gear value threshold, receiving a first efficiency value corresponding to a current gear and a second efficiency value corresponding to a first gear of the number of available gears of the transmission; and
implementing a gear shift that causes the transmission to operate at the first gear, responsive to the second efficiency value being below the first efficiency value.

10. The method of claim 9, wherein the predetermined gear value threshold is zero.

11. The method of claim 9, wherein the available gear value is received responsive to receiving information comprising at least one of a road grade value, a vehicle speed value, or throttle change rate value, and wherein the available gear value is based on the received information.

12. The method of claim 9, further comprising:
comparing the first efficiency value and the second efficiency value to a third efficiency value corresponding to a second gear of the number of available gears of the transmission; and
wherein implementing the gear shift comprises causing the transmission to operate at the second gear, responsive to the third efficiency value being below both the first efficiency value and the second efficiency value.

13. The method of claim 9, further comprising:
responsive to the available gear value being above the predetermined gear value threshold, receiving a first exhaust gas temperature value operating in the current gear; and
responsive to the first exhaust gas temperature value being at or below an exhaust gas temperature threshold, comparing the first exhaust gas temperature value to a second exhaust gas temperature value corresponding to a second gear of the number of available gears of the transmission;
wherein implementing the gear shift comprises causing the transmission to operate at the second gear responsive to the second exhaust gas temperature value being above the first exhaust gas temperature value.

14. The method of claim 13, wherein the first gear and the second gear are the same gear.

15. The method of claim 13, wherein the first efficiency value and the second efficiency value are received responsive to the first exhaust gas temperature value being below the exhaust gas temperature threshold.

16. The method of claim 9, wherein the first efficiency value corresponding to the current gear is based on at least one of an engine speed value, an engine torque value, or a vehicle speed value.

17. A non-transitory computer-readable medium having computer-executable instructions embodied therein that, when executed by at least one processor of a computing system, cause the computing system to perform operations comprising:
receiving an available gear value regarding a number of available gears of a transmission;
responsive to the available gear value being above a predetermined gear value threshold, receiving a first exhaust gas temperature value operating at a current gear;
responsive to the available gear value being above the predetermined gear value threshold and the first exhaust gas temperature value being at or below an exhaust gas temperature threshold, receiving a first efficiency value corresponding to the current gear, a second efficiency value corresponding to a first gear of the number of available gears of the transmission, and a second exhaust gas temperature value for a vehicle operating at the first gear; and
implementing a gear shift comprising at least one of:
causing the transmission to operate at the first gear responsive to the second efficiency value being below the first efficiency value; or
causing the transmission to operate at the first gear responsive to the second exhaust gas temperature value being above the first exhaust gas temperature value.

18. The non-transitory computer-readable medium of claim 17, wherein the available gear value is received responsive to receiving information comprising at least one of a road grade value, a vehicle speed value, or throttle change rate value, and wherein the available gear value is based on the received information.

19. The non-transitory computer-readable medium of claim 17, wherein the first efficiency value corresponding to the current gear is based on at least one of an engine speed value, an engine torque value, or a vehicle speed value.

20. The non-transitory computer-readable medium of claim 17, wherein the predetermined gear value threshold is zero.
